(19) United States
(12) Patent Application Publication
(10) Pub. No.: US 2012/0069843 A1
(43) Pub. Date: Mar. 22, 2012

(54) COMMUNICATION SYSTEM

(75) Inventor: Hirokazu TSUBOTA, Kanagawa (JP)

(73) Assignee: FUJI XEROX CO., LTD., TOKYO (JP)

(21) Appl. No.: 13/013,201

(22) Filed: Jan. 25, 2011

(30) Foreign Application Priority Data
Sep. 22, 2010 (JP) 2010-211546

(51) Int. Cl. H04L 12/56

(52) U.S. Cl. 370/389

(57) ABSTRACT

A communication system includes: a first communication device; and a second communication device; the first communication device including: an identification information addition unit that adds an identification information to identify data to the data to be transmitted to the second communication device via a transmission path; and a transmitter that transmits the data to which the identification information is added by the identification information addition unit; and the second communication device including: a receiver that receives the data, to which the identification information is added, from the first communication device via the transmission path; and a distribution unit that distributes the data received by the receiver to a processing unit that executes a given process corresponding to the identification information.

### CROSS-REFERENCE TO RELATED APPLICATION

This application is based on and claims priority under 35 USC 119 from Japanese Patent Application No. 2010-211546 filed on Sep. 22, 2010.

### BACKGROUND

(i) Technical Field

The present invention relates to a communication system.

(ii) Related Art

Recently, a transmission of a large amount of data such as high-quality image data between communication devices via a transmission path leads the increase of transmission band of the transmission path. When transmitting a large amount of data, the transmission band may be ensured by performing a transmission with a transmission path including multiple cables.

### SUMMARY

According to an aspect of the present invention, there is provided a communication system including: a first communication device; and a second communication device; the first communication device including: an identification information addition unit that adds an identification information to identify data to the data to be transmitted to the second communication device via a transmission path; and a transmitter that transmits the data to which the identification information is added by the identification information addition unit; and the second communication device including: a receiver that receives the data, to which the identification information is added, from the first communication device via the transmission path; and a distribution unit that distributes the data received by the receiver to a processing unit that executes a given process corresponding to the identification information.

### BRIEF DESCRIPTION OF THE DRAWINGS

Exemplary embodiments of the present invention will be described in detail based on the following figures, wherein:

FIG. 1 is a block diagram illustrating a composition of an image forming apparatus and components surrounding thereto in accordance with a first exemplary embodiment;

FIGS. 2A and 2B are block diagrams illustrating a composition of a communication system in accordance with the first exemplary embodiment;

FIGS. 3A and 3B are block diagrams illustrating another example of a composition of the communication system in accordance with the first exemplary embodiment;

FIG. 4 is a diagram illustrating a packet data structure in accordance with the first exemplary embodiment;

FIG. 5 is a flowchart illustrating a process of transmitting data in a communication device in accordance with the first exemplary embodiment;

FIG. 6 is a flowchart illustrating a process of receiving data in the communication device in accordance with the first exemplary embodiment;

FIG. 7 is a diagram illustrating a table that associates a source ID with a destination ID in accordance with the first exemplary embodiment;

FIGS. 8A and 8B are block diagrams illustrating a composition of a communication system in accordance with a second exemplary embodiment; and

FIG. 9 is a flowchart illustrating a process of outputting a status of a connection between cables and connectors in accordance with the second exemplary embodiment.

### DETAILED DESCRIPTION

A description will now be given, with reference to the accompanying drawings, of exemplary embodiments of the present invention.

### First Exemplary Embodiment

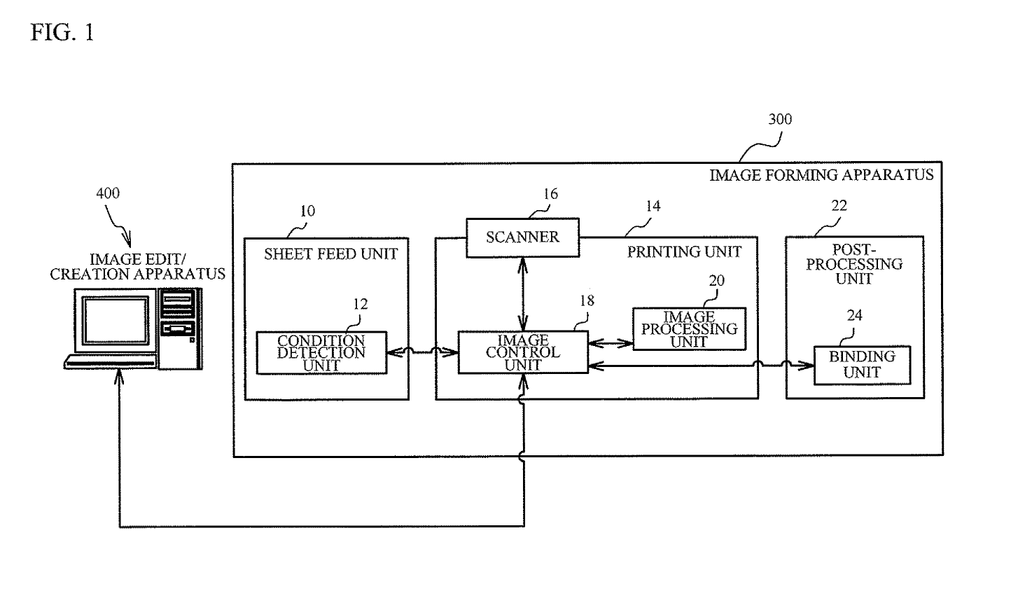

FIG. 1 is a block diagram illustrating a composition of an image forming apparatus 300 and components surrounding thereto in accordance with a first exemplary embodiment as an example of a communication device and a communication system. As illustrated in FIG. 1, the image forming apparatus 300 is provided with a sheet feed unit 10, a printing unit 14 and a post-processing unit 22. The sheet feed unit 10 includes a condition detection unit 12. The printing unit 14 includes a scanner 16, an image control unit 18 and an image processing unit 20. The post-processing unit 22 includes a binding unit 24. The condition detection unit 12, the scanner 16, the image control unit 18, the image processing unit 20 and the binding unit 24 that are located in the image forming apparatus 300 communicate via transmission paths illustrated by arrowed lines. An image edit/creation apparatus 400 that locates outside of the image forming apparatus 300 communicates with the image forming apparatus 300 via a transmission path illustrated by an arrowed line. Contents of communication include image data, commands representing instructions for processing and the like for example.

The sheet feed unit 10 feeds sheets to be printed. The condition detection unit 12 detects a color, size and the like of the sheet to be printed, and sends data about the detected color, size and the like of the sheet to the image control unit 18. The printing unit 14 prints image data on the sheet. The scanner 16 reads image data inputted for printing, and sends image data to the image control unit 18. The image control unit 18 sends image data to the image processing unit 20 and the image edit/creation apparatus 400 such as an external computer, for example. The image processing unit 20 receives image data from the image control unit 18, and executes a process of enlarging or reducing image data and a color correction process, for example. The post-processing unit 22 executes a post-process such as a distribution, fold, trim, and binding of printed sheets, for example. The binding unit 24 receives information about a position where printed sheets are bound and a direction of sheets, and executes a binding. The image edit/creation apparatus 400 edits image data received from the image control unit 18, or creates image data, and transmits image data to the image control unit 18. As described above, the image forming apparatus 300 and the image edit/creation apparatus 400 correspond to communication devices, and are part of a communication system. Each unit located in the image forming apparatus 300 corresponds to a communication device, and is a part of a communication system. For example, the condition detection unit 12 and the image control unit 18 correspond to communication devices, and are part of a communication system. The composition illustrated in FIG. 1 is an example of a communication device and a communication system, and may be other composition.

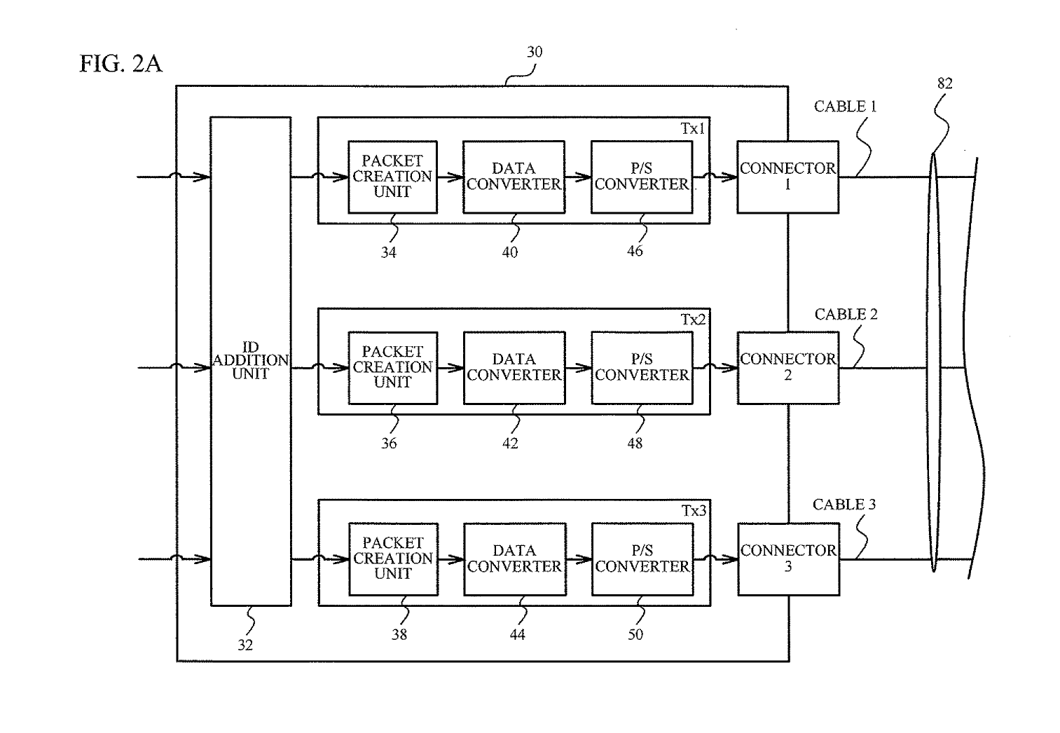

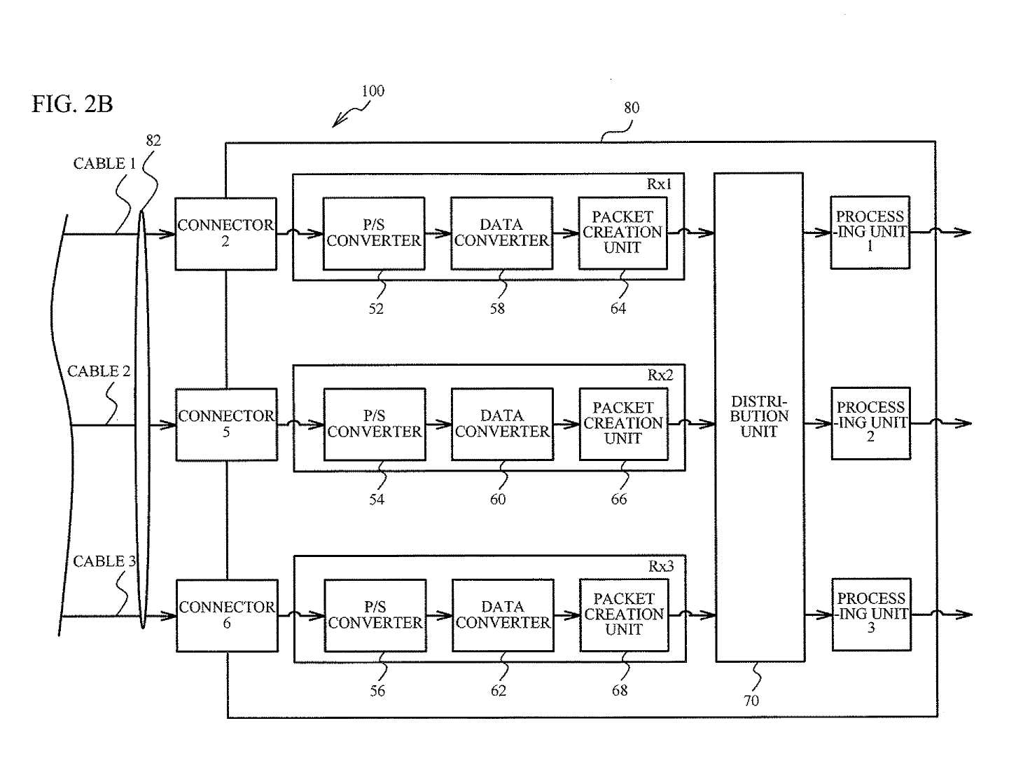

FIGS. 2A and 2B are block diagrams illustrating a composition of a communication system 100 in accordance with the first exemplary embodiment. The communication system 100 is provided with a communication device 30 and a communication device 80. In the exemplary embodiment illustrated in FIG. 1, the communication device 30 may be the image forming apparatus 300, and the communication device 80 may be the image edit/creation apparatus 400 for example.

Alternatively, the communication device 30 may be the scanner 16, and the communication device 80 may be the image control unit 18. The communication device 30 and the communication device 80 transmit and receive data via a transmission path 82 including multiple cables 1, 2 and 3. Cable 1, 2 and 3 are optical fibers or coaxial cables for example. Cables 1, 2 and 3 are used for transmission of data from the communication device 30 to the communication device 80. Cables 1, 2 and 3 transmit data in a serial format. The colors of coating of cables 1, 2 and 3 are unified. The number of cables illustrated in FIGS. 2A and 2B is an example, and the number of cables may varies.

The communication device 30 includes an identification information addition unit 32, transmitters 1, 2 and 3, and connectors 1, 2 and 3. Hereinafter, identification information (Identifier) will be abbreviated as ID, and a transmitter will be described as Tx. The ID addition unit 32 adds an ID for identifying data to data transmitted to the communication device 80 via the transmission path 82. The ID includes information to identify, among Tx1, Tx2, and Tx3, the transmitter which transmits data. Hereinafter, the information to identify the transmitter which transmits data is referred to as a source ID. For example, the source ID “1” is added to data transmitted from Tx1 and the source ID “2” is added to data transmitted from Tx2. Moreover, the ID includes information to identify, among processing units 1, 2 and 3 described later, the processing unit that processes data. Hereinafter, information to identify the processing unit that processes data is referred to as a destination ID. For example, the destination ID “1” is added to data processed by the processing unit 1, and the destination ID “2” is added to data processed by the processing unit 2. Tx1, Tx2 and Tx3 transmit data, to which the ID is added by the ID addition unit 32, to the communication device 80. Tx1 includes a packet creation unit 34, a data converter 40, and a Parallel/Serial (hereinafter, abbreviated as P/S) converter 46. Tx2 includes a packet creation unit 36, a data converter 42, and a P/S converter 48. Tx3 includes a packet creation unit 38, a data converter 44, and a P/S converter 50. Packet creation units 34, 36 and 38 packetize data. A packet data structure will be described later. Data converters 40, 42 and 44 convert data to a format appropriate for serial transmission. Data converters 40, 42 and 44 convert 8-bit data to 10-bit data with 8b/10b system for example so that the period of “0” or “1” is shorter than a given period, P/S converters 46, 48 and 50 convert data from a parallel format to a serial format. Connectors 1, 2 and 3 are coupled to one end of the cable 1, 2 or 3, and shapes of connectors 1, 2 and 3 are unified. In FIG. 2A, connectors 1, 2 and 3 are coupled with one ends of cables 1, 2 and 3 respectively.

The communication device 80 includes connectors 4, 5 and 6, receivers 1, 2 and 3, a distribution unit 70, and processing units 1, 2, and 3. Hereinafter, a receiver will be described as Rx. Connectors 4, 5 and 6 are coupled to the other end of the cable 1, 2 or 3, and shapes of connectors 4, 5 and 6 are unified. FIG. 2B illustrates a case where connectors 4, 5 and 6 are coupled with other ends of cables 1, 2 and 3 respectively. Rx1, Rx2 and Rx3 receive data to which the ID is added from the communication device 30 via the transmission path 82. Rx1 includes a Serial/Parallel (hereinafter, abbreviated as SIP) converter 52, a data converter 58, and a packet release unit 64. Rx2 includes a S/P converter 54, a data converter 60, and a packet release unit 66. Rx3 includes a S/P converter 56, a data converter 62, and a packet release unit 68. S/P converters 52, 54 and 56 convert data from a serial format to a parallel format. Data converters 58, 60 and 62 execute a conversion process opposite to the conversion process that data converters 40, 42 and 44 execute. For example, when data converters 40, 42 and 44 convert data from an 8-bit format to a 10-bit format with an 8b/10b system, data converters 58, 60 and 62 convert data from a 10-bit format to an 8-bit format. Packet release units 64, 66 and 68 take data from packetized data. The distribution unit 70 distributes data received by Rx1, Rx2 and Rx3 to processing units 1, 2, and 3 based on the ID. Processing units 1, 2 and 3 execute a given process in accordance with the destination ID. For example, the processing unit 1 executes a process to data to which the destination ID “1” is added, and the processing unit 2 executes a process to data to which the destination ID “2” is added.

Referring to FIGS. 2A and 2B, a description will be given of an example of a process of transmitting and receiving data in the communication system 100. Hereinafter, a description will be given of a process of transmitting and receiving data A, the process being executed via the cable 1 coupling the connector 1 with the connector 4. Firstly, data A is input to the communication device 30. The ID addition unit 32 adds the source ID and the destination ID to data A. As data A is transmitted from Tx1, the ID addition unit 32 adds the source ID “1” to data A. As a given process is executed to data A by the processing unit 1, the ID addition unit 32 adds the destination ID “1” to data A. The packet creation unit 34 packetizes data A. The data converter 40 converts data A from an 8-bit format to a 10-bit format. The P/S converter 46 converts data A from a parallel format to a serial format. Data A is transmitted from Tx1 to Rx1 via the cable 1 of which one end is coupled to the connector 1 and the other end is coupled to the connector 4. Rx1 receives data A. The S/P converter 52 converts data A from a serial format to a parallel format. The data converter 58 converts data A from a 10-bit format to an 8-bit format. The packet release unit 64 takes data A from the packetized data A. The distribution unit 70 verifies that the source ID added to data A is “1”, and recognizes that data A is transmitted from Tx1. The distribution unit 70 verifies that the destination ID added to data A is “1”, and distributes data A to the processing unit 1. The processing unit 1 executes a given process in accordance with the destination ID “1” to data A. Then, the process is ended.

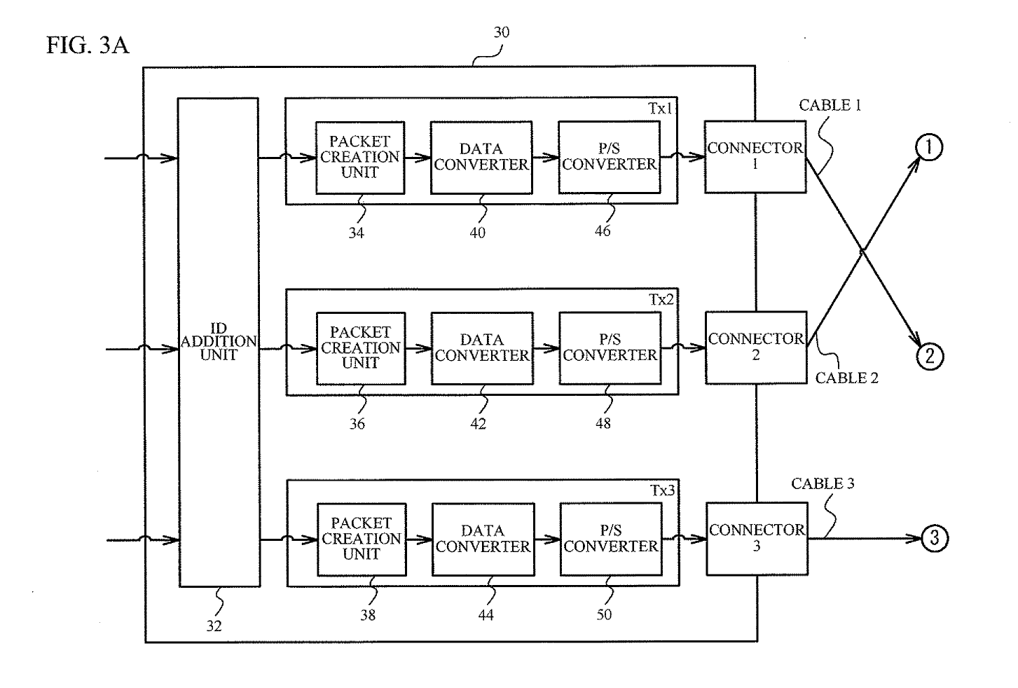

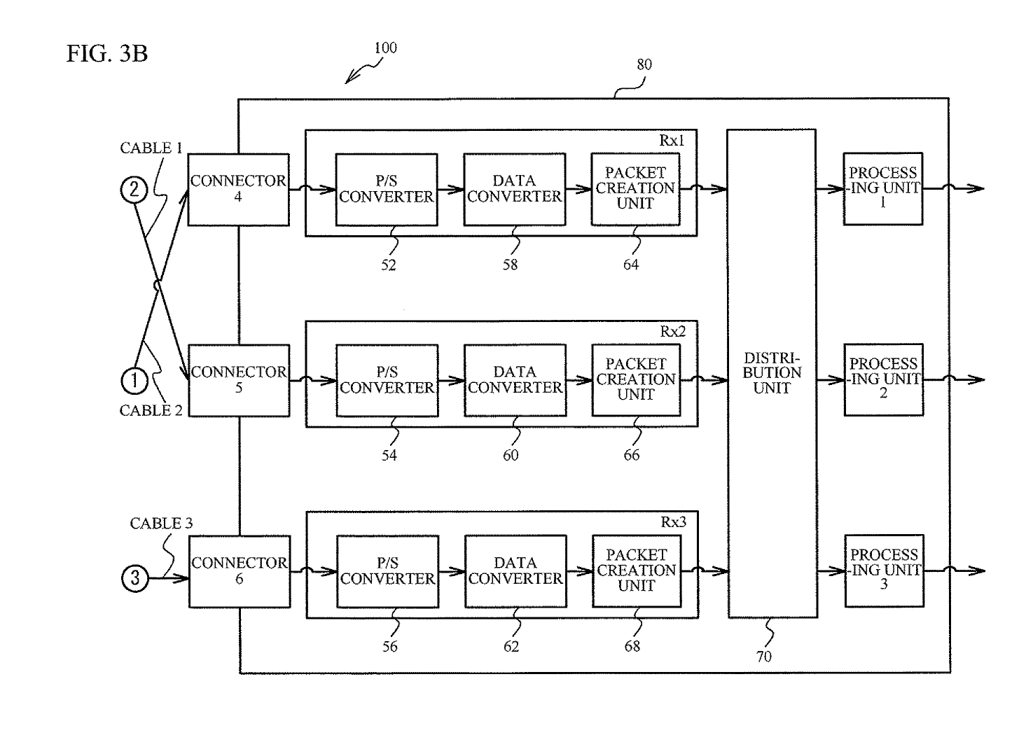

FIGS. 3A and 3B are block diagrams illustrating a composition of the communication system 100 in accordance with the first exemplary embodiment. The composition illustrated in FIGS. 3A and 3B is different from the one illustrated in FIGS. 2A and 2B in that one end of the cable 1 is coupled to the connector 1, the other end of the cable 1 is coupled to the connector, one end of the cable 2 is coupled to the connector 2, and the other end of the cable 2 is coupled to the connector 4. In FIGS. 3A and 3B, same reference numerals are applied to components same as those in FIGS. 2A and 2B, and a description will be omitted. Hereinafter, a description will be given of a process of transmitting and receiving data A via the cable 1 coupling the connector 1 with the connector 5. As procedures from when data A is input to the communication device 30 till when data A is converted to a serial format by the P/S converter 46 are same as those described above with reference to FIGS. 2A and 2B, a description will be omitted. Data A is transmitted from Tx1 to Rx2 via the cable 1 of which one end is coupled to the connector 1 and the other end is coupled to the connector 5, Rx2 receives data A. The S/P converter 54 converts data A from a serial format to a parallel format. The data converter 60 converts data from a 10-bit format to an 8-bit format. The packet release unit 66 takes data A from the packetized data A. The distribution unit 70 verifies that the source ID added to data A is “1”, and recognizes that data A is transmitted from Tx1. The distribution unit 70 verifies that the destination ID added to data A is “1”, and distributes data A to the processing unit 1. The processing unit 1 executes a given process in accordance with the destination ID “1” to data A. Then the process is ended. As described above, even though the other end of the cable 1 is coupled with to connector 5 instead of the connector 4, the transmission/reception of data A is carried out reliably in the same manner as a case that the other end of the cable 1 is coupled to the connector 4.

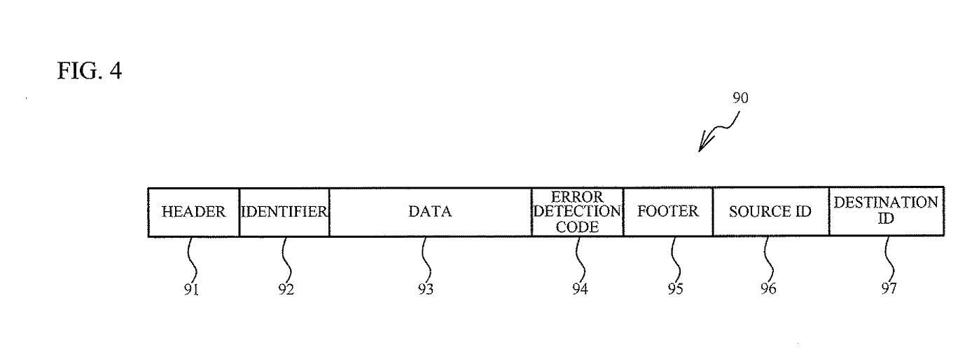

FIG. 4 is a diagram illustrating a data structure of a packet in accordance with the first exemplary embodiment. The name of each field is “header 91”, “identifier 92”, “data 93”, “footer 95”, “source ID 96”, and “destination ID 97”. In a description hereinafter, the field name will be put in double quotation marks, and the value stored in each field will be put in single quotation marks.

As illustrated in FIG. 4, information representing a beginning of packet and an end of packet is stored in “header 91” and “footer 95” respectively. The type of data stored in “data 93” may be stored in “header 91” and “footer 95”. For example, information indicating that data stored in “data 93” is image data or a control command may be stored in “header 91” and “footer 95”. Identification information to identify data stored in “data 93” is stored in “identifier 92”. The address of a storage unit such as a memory where the communication device 80 stores data may be stored in “identifier 92”. Data to be transmitted to the communication device 80 via the transmission path 82 is stored in “data 93”. For example, in a case where data A is transmitted to the communication device 80 via the transmission path 82, packet creation units 34, 36 and 38 store ‘data A’ in “data 93”. Packet release units 64, 66 and 68 take ‘data A’ from “data 93”. Data for detecting error of data 93 is stored in “error detection code 94”. For example, data such as Cyclic Redundancy Check (CRC) is stored in “error detection code 94”. The presence of error is checked by the packet by using data stored in “error detection code 94”. “Error detection code 94” may be “error correction code 94”, and may store data of an error correction code such as a hamming code. The source ID and the destination ID described above are stored in “source ID 96” and “destination ID 97” respectively.

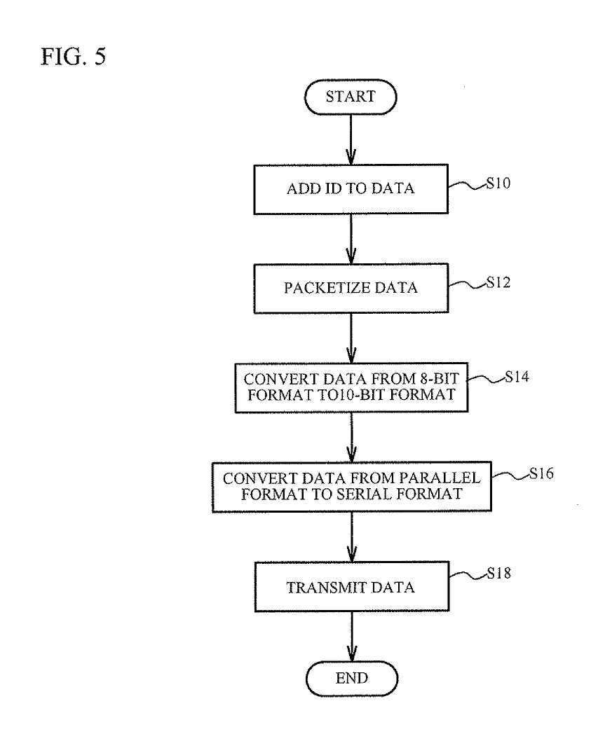

FIG. 5 is a flowchart illustrating a process of transmitting data in the communication device 30 in accordance with the first exemplary embodiment. As illustrated in FIG. 5, the ID addition unit 32 adds the source ID and the destination ID to data inputted to the communication device 30 (step S10). Packet creation units 34, 36 and 38 packetize data (step S12). Data converters 40, 42 and 44 convert data from an 8-bit format to a 10-bit format (step S14). P/S converters 46, 48 and 50 convert data from a parallel format to a serial format (step S16). Tx1, Tx2 and Tx3 transmit data to the communication device 80 via cables 1, 2 and 3 of which one ends are coupled to connectors 1, 2 or 3 and the other ends are coupled to connectors 4, 5 or 6 (step S18).

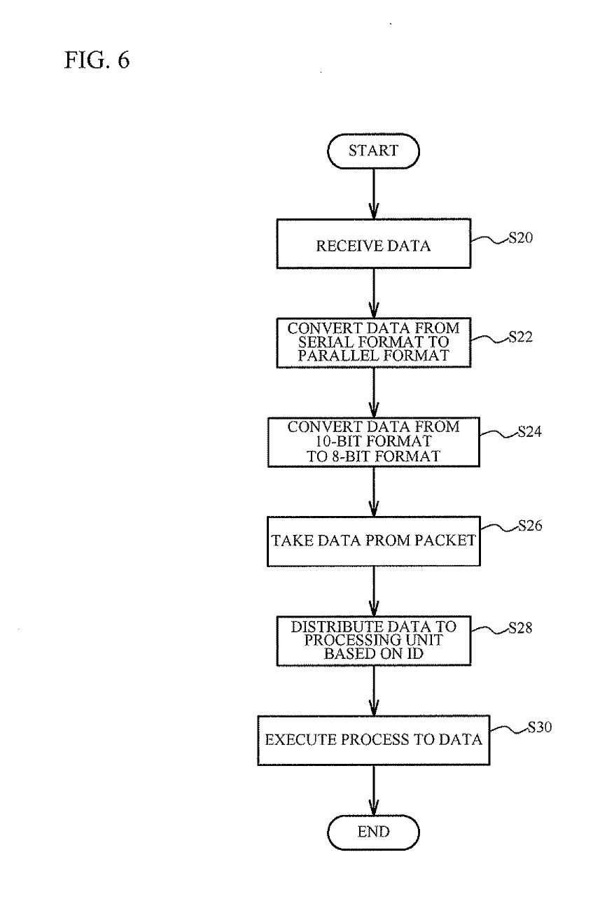

FIG. 6 is a flowchart illustrating a process of transmitting data in the communication device 80 in accordance with the first exemplary embodiment. As illustrated in FIG. 6, Rx1, Rx2 and Rx3 receive data (step S20). S/P converters 52, 54 and 56 convert data from a serial format to a parallel format (step S22). Data converters 58, 60 and 62 convert data from a 10-bit format to an 8-bit format (step S24). Packet release units 64, 66 and 68 take data stored in “data 93” of the packet. The distribution unit 70 distributes data to processing units 1, 2, or 3 based on the source ID and the destination ID added to data (step S28). Processing units 1, 2, and 3 execute a given process to distributed data (step S30).

As described above, according to the first exemplary embodiment, the ID addition unit 32 adds the identification information to identify data to data to be transmitted to the communication device, which corresponds to a second communication device, via the transmission path 82 as described in the step S10 in FIG. 5. The distribution unit 70 distributes data received by Rx1, Rx2 and Rx3 to processing units 1, 2, or 3, which executes a given process according to the ID, based on the ID as described in the step S28 in FIG. 6. Accordingly, even though one ends of cables 1, 2 and 3 are coupled to any of connectors 1, 2 and 3 and the other ends of cables 1, 2 and 3 are coupled to any of connectors 4, 5 or 6, the data communication from the communication device 30 to the communication device 80 is carried out reliably, and the process to data is executed reliably. Therefore, the reliability of the communication between communication devices is improved. In the communication device that communicates via multiple cables, there is a case that cables and connectors to which the cables are coupled are unified to prevent the difference of transmission quality among cables. In such case, it is difficult for a user to distinguish each cable and each connector, and thus cables are easily connected to connectors wrongly. When a cable is not coupled to a connector correctly, the data communication between communication devices may be failed, and the liability of the communication may be reduced. However, by applying the composition described in the first exemplary embodiment, the data communication between communication devices is carried out reliably even though a cable is coupled to a connector wrongly.

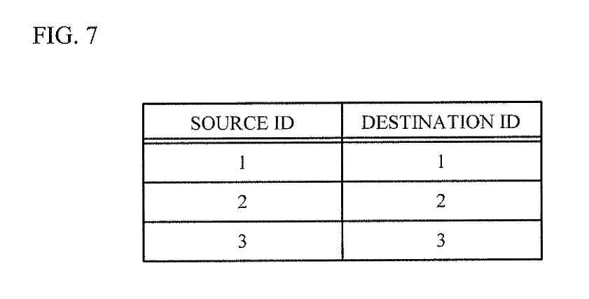

In the first exemplary embodiment, the source ID which is information to identify, among Tx1, Tx2 and Tx3, the transmitter from which data is transmitted, and the destination ID which is information to identify, among processing units 1, 2 and 3, the processing unit where data is processed are described as examples of the ID that the ID addition unit 32 adds to data. The ID addition unit 32 may add both the source ID and the destination ID to data, or may add either one of the source ID and the destination ID to data. When the ID addition unit 32 adds either one of the source ID and the destination ID, the distribution unit 70 preliminarily stores a table (ID table) that associates the source ID with the destination ID as illustrated in FIG. 7 to a storage unit such as a memory. FIG. 7 is a diagram illustrating an example of a table that associates the source ID with the destination ID in accordance with the first exemplary embodiment. When the distribution unit 70 confirms that the source ID is added to data, it may verify the destination ID associated with the source ID by referring to the ID table, and distribute data to the processing unit corresponding to the verified destination ID. According to this, the size of each packet becomes smaller, and thus the transmission efficiency is improved. The source ID and the destination ID may be the unique number such as manufacturer's serial numbers of Tx1, Tx2 and Tx3 and Rx1, Rx2 and Rx3, or the number updated dynamically.

In the first exemplary embodiment, a description was given of a case where shapes of connectors 1, 2 and 3 are unified to prevent the difference of transmission quality between cables. Moreover, a description was also given of a case where colors of coating of cables 1, 2 and 3 are unified. Pole number of each connector may be unified in addition to the shape of each connector for example. The length of each cable may be unified in addition to the color of coating of each cable for example.

### Second Exemplary Embodiment

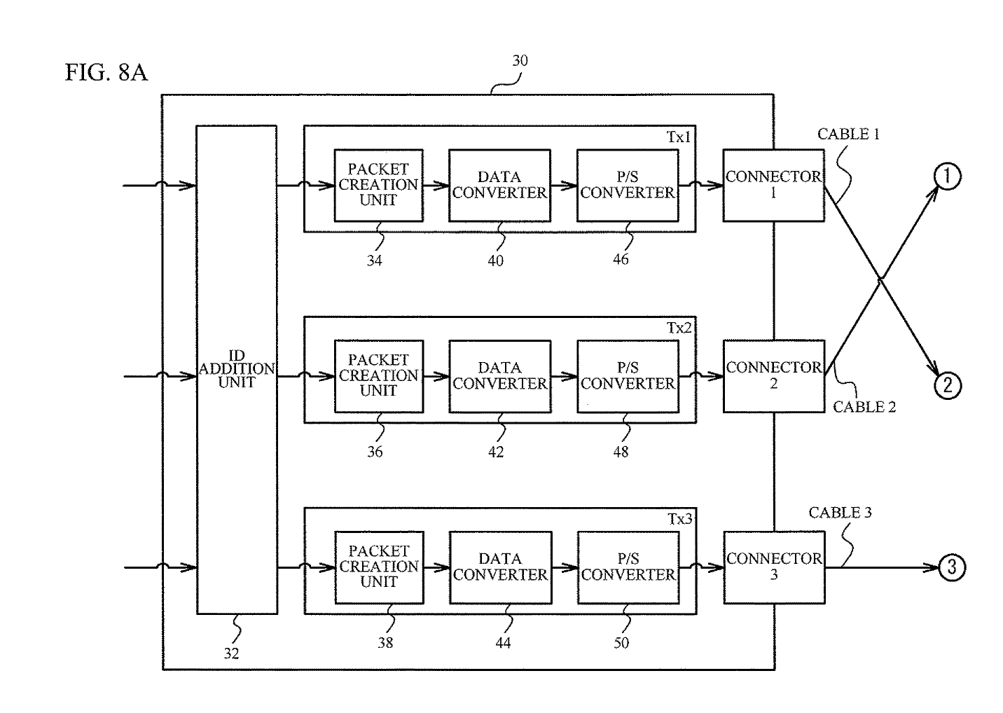

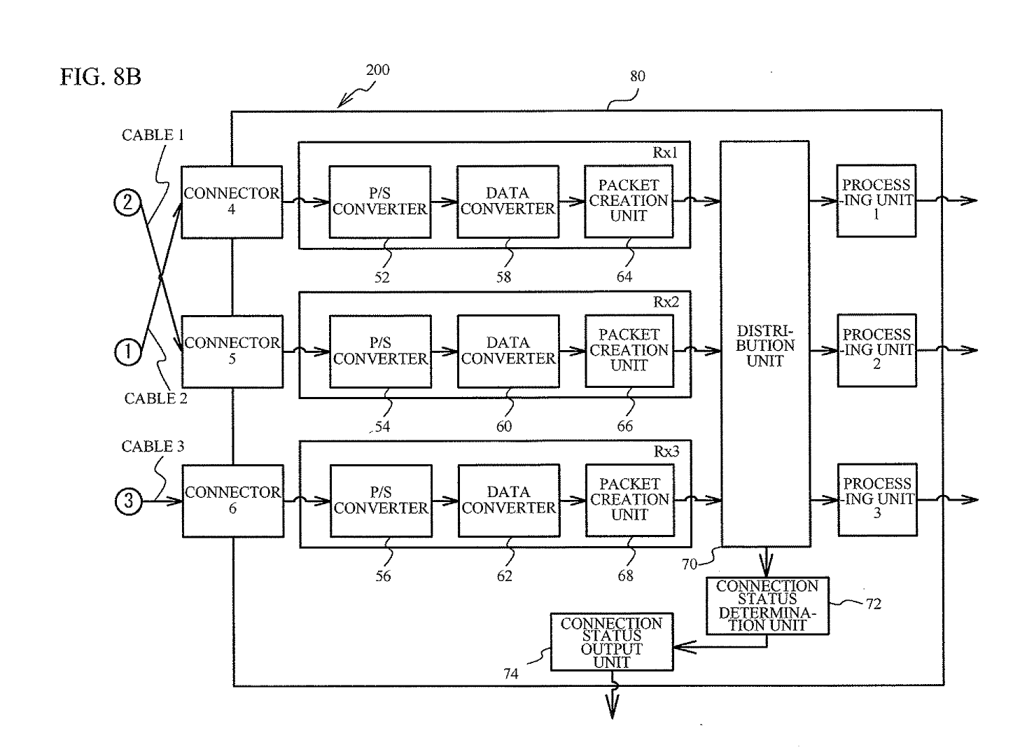

FIGS. 8A and 8B are block diagrams illustrating a composition of a communication system 200 in accordance with a second exemplary embodiment. The communication system 200 in FIGS. 8A and 8B is different from the communication system 100 in FIGS. 3A and 3B in that the communication device 80 includes a connection status determination unit 72 and a connection status output unit 74. In FIGS. 8A and 8B, same reference numerals are applied to components same as those in FIGS. 3A and 3B, and a description will be omitted. In the communication system 200, it is preliminarily determined that in a normal connection status, the connector 1 is coupled to the connector 4, the connector 2 is coupled to the connector 5, and the connector 3 is coupled to the connector 6. Moreover, it is preliminarily determined that processing units 1, 2, and 3 execute processes to data received via connectors 4, 5 and 6 respectively.

As illustrated in FIG. 8B, the connection status determination unit 72 determines the connection status between cables 1, 2 and 3 and connectors 4, 5 and 6 based on the ID added to data. The connection status output unit 74 outputs the connection status determined by the connection status determination unit 72. The connection status output unit 74 may be a light emitting device such as LED (Light Emitting Diode), a liquid crystal panel or the like. A number of connection status output units 74 may be provided with respect to each connector.

Referring to FIGS. 8A and 8B, a description will be given of an example of a process of outputting the connection status between cables 1, 2 and 3 and connectors 4, 5 and 6. Firstly, a description will be given of a case where the connection status between cables 1, 2 and 3 and connectors 4, 5 and 6 is normal. For example, assume that the distribution unit 70 verifies that the source ID added to data received by Rx3 is “3”. In this case, the connection status determination unit 72 determines that the connector 6 is coupled to the connector 3 via the cable 3 as illustrated in FIGS. 8A and 8B because data received by Rx3 is data transmitted from Tx3. The connection status determination unit 72 informs the connection status output unit 74 that the connector 6 is coupled to the connector 3. The connection status output unit 74 outputs information representing that the connector 6 is coupled to the connector 3. At this time, as the connection between the connector 6 and the connector 3 is a normal connection, the connection status output unit 74 may also output information representing that the connection between the connector 6 and the connector 3 is normal. When the connection status output unit 74 is an LED for example, the LED turns green. A user confirms that a cable is coupled to a connector normally.

A description will now be given a case where the connection between cables 1, 2 and 3 and connectors 4, 5 and 6 is abnormal. For example, assume that the distribution unit 70 verifies that the source ID added to data received by Rx2 is “1”. In this case, the connection status determination unit 72 determines that the connector 5 is coupled to the connector 1 via the cable 1 as illustrated in FIGS. 8A and 8B because data received by Rx2 is data transmitted from Tx1. The connection status determination unit 72 informs the connection status output unit 74 that the connector 5 is coupled to the connector 1. The connection status output unit 74 outputs information that the connector 5 is coupled to the connector 1. At this time, as the connection between the connector 5 and the connector 1 is an abnormal connection, the connection status output unit 74 may output information that the connection between the connector 5 and the connector 1 is abnormal. When the connection status output unit 74 is an LED, it turns red, informs a user that the connection between a cable and a connector is abnormal, and prompts the normal connection.

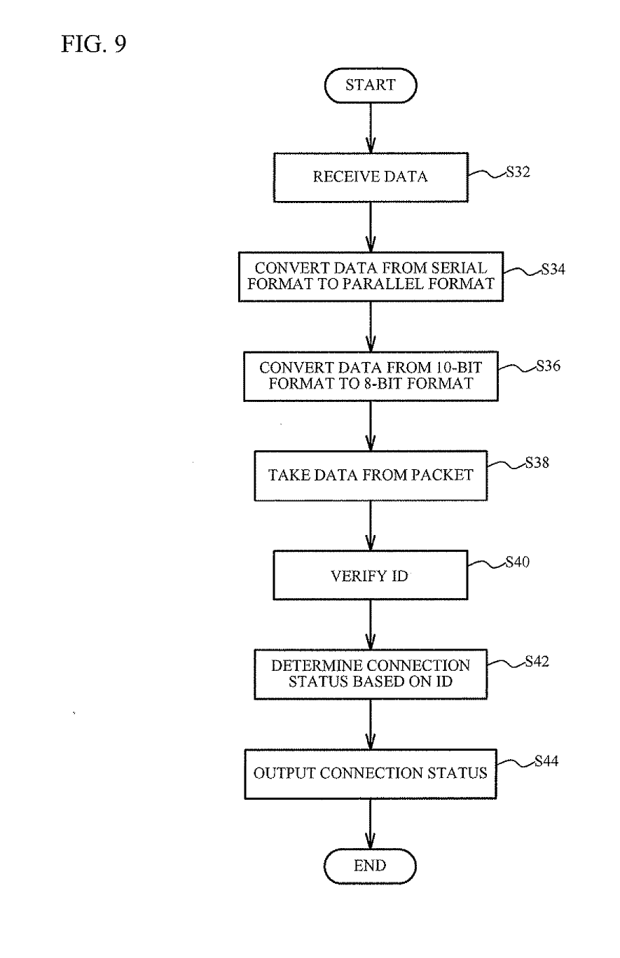

FIG. 9 is a flowchart illustrating a process of outputting the connection status between cables 1, 2 and 3 and connectors 4, 5 and 6 in accordance with the second exemplary embodiment. Steps 32, S34, S36 and S38 illustrated in FIG. 9 are same as steps S20, S22, S24 and S26 illustrated in FIG. 6 respectively, and thus a description is omitted. As illustrated in FIG. 9, the distribution unit 70 verifies the source ID added to data (step S40), and notifies the connection status determination unit 72 of the source ID. The connection status determination unit 72 determines the connection status between cables 1, 2 and 3 and connectors 4, 5 and 6 based on the source ID (step S42), and notifies the connection status output unit 74 of the connection status. The connection status output unit 74 outputs the connection status (step S44).

As described above, according to the second exemplary embodiment, the connection status determination unit 72 determines the connection status between cables and connectors 4, 5 and 6 based on the ID as described in the step S42 in FIG. 9. Here, connectors 4, 5 and 6 correspond to second connectors. The connection status output unit 74 outputs the connection status determined by the connection status determination unit 72 as described in the step S44 in FIG. 9.

In the second exemplary embodiment, a description was given of a case where the connection status determination unit 72 determines the connection status between cables and second connectors based on the source ID. For example, assume that one end of the cable is coupled to the connector of the communication device of the destination and the other end of the cable is coupled to the connector of the communication device of the transmission source, when the cable of which the communication direction is preliminarily determined to a given direction, one end is preliminarily determined to be coupled to the connector of the communication device of the source, and the other end is preliminarily determined to be coupled to the connector of the communication device of the destination is used. In this case, the signal does not flow normally, data is not received in the communication device of the destination. When data is not received for a given period, the connection status determination unit 72 may determine that the connection status of the cable is abnormal or that a problem such as disconnection happens to the cable. The connection status output unit 74 may output the result of above determination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A communication system comprising:
a first communication device; and
a second communication device;
the first communication device including:
an identification information addition unit that adds an identification information to identify data to the data to be transmitted to the second communication device via a transmission path; and
a transmitter that transmits the data to which the identification information is added by the identification information addition unit; and
the second communication device including:
a receiver that receives the data, to which the identification information is added, from the first communication device via the transmission path; and
a distribution unit that distributes the data received by the receiver to a processing unit that executes a given process corresponding to the identification information.

2. The communication system according to claim 1, wherein the transmitter includes a plurality of transmission units, and the identification information includes information to identify, among the plurality of transmission units, a transmission unit from which the data is transmitted.

3. The communication system according to claim 1, wherein the transmission path is comprised of cables,
the first communication device includes first connectors which are coupled to any one of one ends of the cables and of which shapes are unified, and
the second communication device includes second connectors which are coupled to any one of other ends of the cables and of which shapes are unified.

4. The communication system according to claim 1, wherein colors of coating of the cables are unified.

5. The communication system according to claim 3, wherein the second communication device includes:
a connection status determination unit that determines a connection status between the cables and the second connectors based on the identification information; and
a connection status output unit that outputs the connection status determined by the connection status determination unit.
